(19) United States
(12) Patent Application Publication
(10) Pub. No.: US 2021/0234253 A1
(43) Pub. Date: Jul. 29, 2021

(54) VEHICLE WINDOW GLASS WITH TERMINAL

(71) Applicant: AGC INC., Tokyo (JP)

(72) Inventors: Yoshiyuki KUWAHARA, Tokyo (JP); Yuukou MINAMIYA, Tokyo (JP)

(73) Assignee: AGC INC., Tokyo (JP)

(21) Appl. No.: 17/093,521

(22) PCT Filed: May 24, 2019
(86) PCT No.: PCT/JP2019/020738

§ 371 Date: Nov. 9, 2020

(30) Foreign Application Priority Data
Jun. 5, 2018 (JP) 2018-107844

(51) Int. Cl. H01Q 1/12; H01R 12/57; H01R 4/70; H01R 12/75; B60J 1/00; H05B 3/86

(52) U.S. Cl. CPC H01Q 1/1278; H01R 12/57; H01R 4/70; B60S 1/026; B60J 1/002; H05B 3/86; H01R 12/75

(57) ABSTRACT

A vehicle window glass with a terminal includes a glass plate, and a terminal connected, by lead-free solder, to an electrically conductive layer disposed on a surface of the glass plate, wherein the terminal at least one leg connected to the electrically conductive layer by the lead-free solder, and wherein at least one portion of the leg is covered with a thermal insulating member.

### CROSS-REFERENCE TO RELATED APPLICATIONS

This application is a continuation of PCT Application No. PCT/JP2019/020738, filed on May 24, 2019, which is based upon and claims the benefit of priority from Japanese Patent Application No. 2018-107844 filed on Jun. 5, 2018. The contents of those applications are incorporated herein by reference in their entireties.

### TECHNICAL FIELD

The present invention relates to a vehicle window glass with a terminal.

### BACKGROUND ART

A vehicle window glass has an electrically conductive layer made of a conductive material, disposed on a glass surface to serve as, e.g., a defogger for the purpose of defogging, or an antenna for a radio receiver, a TV receiver or radio communication. In the case of a defogger for the purpose of defogging, silver paste or another material is baked on a glass surface to dispose a heater pattern or bus bars thereon. In the case of an antenna, silver paste or another material is likewise baked on a glass surface to dispose a pattern thereon so as to be suited to various kinds of applications, such as AM broadcasting, FM broadcasting, terrestrial broadcasting, or satellite broadcasting.

The electrically conductive layer, which is required to receive and send a power or signal for these devices, is connected to a power supply circuit or a signal processing circuit through a terminal at a terminal portion thereof. Heretofore, leaded solder has been used to connect the electrically conductive layer to the terminal coupled to such a circuit. The use of leaded solder facilitates residual stress relaxation during soldering because of being having an excellent adhesive function and a high deformability. For this reason, the electrically conductive layer on a glass surface has been capable of being easily bonded to the terminal by leaded solder. Whereas, it has been recently pointed out that lead has an adverse effect on humans or environment. From this point of view, the use of lead-free solder is said to be preferred for the application of a vehicle window glass.

Lead-free solder has a higher Young's modulus and a higher rigidity than leaded solder. For this reason, when an electrically conductive layer is connected to a terminal by lead-free solder, there is caused a problem that a crack could be formed, or peeling could occur in a glass plate in a hot and cold cycle test for evaluation of a vehicle window glass.

Patent Document 1 listed below discloses a glass plate wherein an electrically conductive layer disposed on a glass surface is connected to a connection element containing chromium-containing steel by use of lead-free solder.

### PRIOR ART DOCUMENTS

### Patent Documents

Patent Document 1: JP-A-2014-519149

### DISCLOSURE OF INVENTION

### Technical Problem

The terminal (connection element) connected to the glass plate disclosed in Patent Document 1 has a coefficient of thermal expansion of 9×10⁻⁶ to 13×10⁻⁶/° C., which is close to 8.5×10⁻⁶ to 9×10⁻⁶/° C. as the coefficient of thermal expansion of glass. For this reason, it is possible to reduce thermal stress caused between the glass plate and the terminal in the hot and cold cycle test.

The terminal connected to the glass plate disclosed in Patent Document 1 contains 50 mass % to 89.5 mass % of iron and 10.5 mass % to 20 mass % of chromium. Iron has an electrical resistivity of 1.00×10⁻⁷ Ω·m, and chromium has an electrical resistivity of 1.29×10⁻⁷ Ω·m. In contrast, copper has an electrical resistivity of 1.68×10⁻⁸ Ω·m, and brass has an electrical resistivity of 6.00×10⁻⁸ Ω·m. In other words, the terminal containing much iron or chromium disclosed in Patent Document 1 has a higher electrical conductivity than the conventional terminal made of copper or brass (tombac).

In a case where the terminal connected to the glass plate disclosed in Patent Document 1 is used for a defogger for the purpose of defogging for example, when the terminal per se has a high electrical resistivity, the heat generation of the terminal becomes large because a relatively large current flows in the terminal. For this reason, the glass plate could be locally heated. In a case where the terminal connected to the glass plate disclosed in Patent Document 1 is used as a terminal for an antenna for example, when the terminal per se has a high electrical resistivity, a received or sent signal could be attenuated in the terminal.

It is an object of the present invention to provide a technique to solve the above-identified problem.

### Solution to Problem

In order to solve the problem, the vehicle window glass with a terminal according to one aspect of the present invention is a vehicle window glass with a terminal, which includes a glass plate, and a terminal connected, by lead-free solder, to an electrically conductive layer disposed on a surface of the glass plate,

wherein the terminal includes at least one leg connected to the electrically conductive layer by the lead-free solder, and

wherein at least one portion of the leg is covered with a thermal insulating member.

### Advantageous Effects of Invention

The present invention provides a vehicle window glass with a terminal, which is capable of preventing a crack from being formed or peeling from being caused in a glass plate in the hot and cold cycle test, which has a terminal connected, by lead-free solder, to an electrically conductive layer disposed on a surface thereof, of making the heat generation of the terminal difficult even when a relatively large current flows in the terminal, and of controlling the attenuation in a signal in the terminal.

### BRIEF DESCRIPTION OF DRAWINGS

FIG. 1 is a front view of the vehicle window glass with a terminal according to a first embodiment of the present invention.

FIG. 2 is a cross-sectional view of a portion of the vehicle window glass with a terminal illustrated in FIG. 1, taken along line A-A in FIG. 1.

FIG. 3 is a plan view of a terminal portion of the vehicle window glass with a terminal illustrated in FIG. 1.

FIG. 4 is a cross-sectional view of a portion of the vehicle window glass with a terminal according to a first modification of the first embodiment illustrated in FIG. 1, taken along line A-A in FIG. 1.

FIG. 5 is a cross-sectional view of a portion of the vehicle window glass with a terminal according to a second modification of the first embodiment illustrated in FIG. 1, taken along line A-A in FIG. 1.

FIG. 6 is a front view of the vehicle window glass with a terminal according to a second embodiment of the present invention.

FIG. 7 is a cross-sectional view of a portion of the vehicle window glass with a terminal illustrated in FIG. 6, taken along line B-B in FIG. 6.

FIG. 8 is a plan view of a terminal-mounting area of the vehicle window glass with a terminal illustrated in FIG. 6.

### DESCRIPTION OF EMBODIMENTS

Now, embodiments of the present invention will be exemplarily described in detail in reference to the accompanying drawings. It should be noted that the elements described in connection with the following embodiments are exemplary only, and that the spirit and scope of the present invention is not limited to these elements only. The vehicle window glass with a terminal according to each of the embodiments is used as, e.g., a backlite or a windshield. The vehicle window glass with a terminal is not limited to such applications. When the vehicle window glass with a terminal illustrated in each of FIGS. 2, 4, 5 and 7 is mounted to a vehicle, the vehicle window glass is served as having a lower side and an upper side in each of the figures positioned on an exterior side and an interior side of the vehicle, respectively.

### First Embodiment

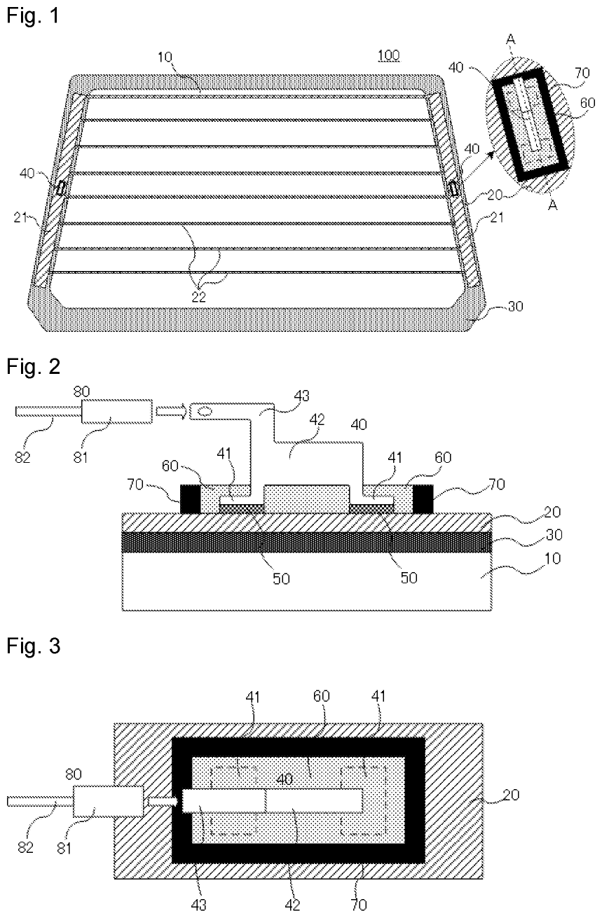

As shown in FIG. 1, the vehicle window glass with a terminal 100 according to a first embodiment of the present invention includes an electrically conductive layer 20 disposed on at least one of primary surfaces of a vehicle window glass 10, and a terminal 40 connected to the electrically conductive layer 20.

The vehicle window glass 10 may be, for example, formed of soda lime glass, borosilicate glass, alkali-free glass or quartz glass without particular limitations. Among them, soda lime glass is particularly preferred. The glass plate 10 may be formed of either non-tempered glass or tempered glass. Non-tempered glass is prepared by forming molten glass in a plate shape and annealing the formed glass. Tempered glass is prepared by forming a compressive stress layer on a surface of non-tempered glass. Tempered glass may be either physically tempered glass (such as glass tempered by air quenching) or chemically tempered glass. When physically tempered glass is used, glass surface may be tempered by quenching a uniformly heated glass plate from a temperature close to its softening point to produce compressive stress on the glass surface by its temperature difference between the glass surface and the inside of the glass plate. When chemically tempered glass is used, the glass surface may be tempered by producing compressive stress on the glass surface by an ion exchange method or the like. Although the vehicle window glass 10 is preferred to be transparent, the vehicle window glass may be a glass plate, which is colored to such an extent not to impair the transparency. Although there is no particular limitation to the thickness of the vehicle window glass 10, the thickness is preferred to be 0.5 to 5.0 mm.

The vehicle window glass 10 may be a single glass plate. The vehicle window glass 10 may be formed of laminated glass wherein exterior-side and interior-side glass plates, which are, respectively, positioned on an exterior side and an interior side when the vehicle window glass 10 is mounted to an automobile, are bonded via an interlayer. The interlayer may be an interlayer formed of polyvinyl butyral (PVB). When the interlayer is particularly required to have water resistance, an ethylene-vinyl acetate copolymer (EVA) is advantageously used. Further, a photopolymerizable acrylic prepolymer, a catalytically polymerizable acrylic prepolymer, a photopolymerizable prepolymer of acrylic ester and vinyl acetate, polyvinyl chloride and so on are also applicable. The exterior-side glass plate and the interior-side glass plate may be the same as each other in terms of composition, shape and thickness or be different from each other in terms of these items.

The vehicle window glass 10 has the electrically conductive layer 20 disposed on a surface thereof. The electrically conductive layer 20 may be disposed by printing and applying, e.g., conductive silver paste on the surface of the vehicle window glass 10, followed by baking. The conductive silver paste is preferred to be a material having an electrical resistivity of 0.5×10⁻⁸ to 9.0×10⁻⁸ Ω·m after disposition. When the vehicle window glass 10 is applied to a backlite, the vehicle window glass 10 has bus bars 21 formed of the electrically conductive layer 20 so as to be disposed on both lateral portions, heating members 22 being disposed between the bus bars 21. Each of the bus bars 21 is electrically connected to a corresponding terminal 40. The heating members 22 achieve the function to remove frost, ice or the like adhering on the vehicle window glass 10 by causing an electric current to flow through the heating members 22 to generate heat when electric power is supplied to the terminals 40 from outside. The heating members 22 may be formed a linear shape as shown in FIG. 1 or in a bent portion or be formed in a mesh shape. The heating members 22 may be formed of a transparent conductive film. The transparent conductive film may be, for example, formed of a metallic film such as an Ag film, a metal oxide film such as an ITO (indium oxide/tin) film, or a resin film containing conductive fine particles. The transparent conductive film may include different kinds of films stacked.

Between the surface of the vehicle window glass 10 and the electrically conductive layer 20 (bus bars 21) may be disposed a light-shielding layer (dark ceramic layer) 30, which is disposed in a strip shape along a periphery area of the vehicle window glass 10 and is dark and opaque such as black. The light-shielding layer 30 achieves the function of protecting, e.g., a urethane sealant for bonding and holding the vehicle window glass 10 to an automobile body, from deterioration caused by an ultraviolet ray. The light-shielding layer also achieves the function of shielding the bus bars 21 and the terminal 40 so as to be invisible from the exterior side when the vehicle window glass 100 with a terminal is mounted to an automobile. The light-shielding layer 30 may be disposed by applying ceramic paste to the surface of the vehicle window glass 10, followed by baking. The light-shielding layer 30 has a thickness of preferably from 3 to 15 μm. Although there is no particular limitation to the width of the light-shielding layer 30, the width is preferred to be 20 to 300 mm.

The terminals 40 may be disposed in the vicinity of an end portion of an upper side or each lateral side of the vehicle window glass 10. The terminals 40 may be disposed on an interior side surface of the vehicle window glass 10 when the vehicle window glass is mounted to a vehicle. When the vehicle window glass 10 is formed of laminated glass, the terminal(s) are disposed on an interior side surface of an interior side glass plate.

As shown in FIG. 2, each terminal 40 includes legs 41, a body 42 electrically connected to the legs 41 and being erected from the leg 41, and a coupling portion 43 extending from the body 42 and electrically connected to the body 42. The number of the legs 41 is one or plural per terminal 40. The coupling portion 43 is electrically coupled to an external circuit coupler 80, which is disposed on a vehicle body and supplies electric power to the electrically conductive layer 20 from an external circuit (not shown) for supplying electric power. The external circuit coupler 80 includes a connector 81 and a cable 82 such that the connector 81 can be inserted into the coupling portion 43 to establish electrical connection between the external circuit and the terminal 40. The external circuit coupler 80 may be electrically coupled to the coupling portion 43 by exposing a conductor in a leading edge of the cable 82 and using solder or a conductive adhesive instead of using the connector 81. Or, physical connection may be established by exposing the conductor in the cable 82 and bending a part of the coupling portion 43 for caulking the conductors.

The legs 41 are preferred to be formed from a material having an electrical resistivity of 1×10⁻⁸ to 10×10⁻⁸ Ω·m. The electrical resistivity is more preferred to be 1×10⁻⁸ to 8×10⁻⁸ Ω·m. In a case the material of the legs 41 has an electrical resistivity of 1×10⁻⁸ to 10×10⁻⁸ Ω·m, even when a relatively large current flows through the terminal 40, the legs 41 are difficult to generate heat, which is preferred. Examples of the material for the legs 41 include copper and brass (tombac).

The terminal 40 may have the legs 41, the body 42 and the coupling portion 43 integrally formed of the same material. In other words, the terminal 40 is preferred to be formed of a material, such as copper, brass (tombac), which has an electrical resistivity of 1×10⁻⁸ to 10×10⁻⁸ Ω·m. When the material for the terminal 40 has an electrical resistivity of 1×10⁻⁸ to 10×10⁻⁸ Ω·m, even when a relatively large current flows through the terminal 40, the terminal 40 is difficult to generate heat as a whole. It should be noted that the leg 41, the body 42 and the coupling portion 43 may be formed of different materials so long as these members are electrically connected and have electrical resistivities in the above-mentioned range.

The legs 41 are electrically connected to the electrically conductive layer 20 by lead-free solder 50. Although there is no particular limitation to the lead-free solder 50, Sn—Ag based solder, Sn—Zn based solder, Sn—Sb based solder, Sn—Ag—In based solder, Sn—Zn—Bi based solder, Sn—Ag—Al—Zn based solder, Sn—Zn—Ti based solder, Sn—Al—In—Ag—Cu—Zn based solder and Sn—Ag—Cu based solder may be mentioned.

At least one portion of each leg 41 is covered with a thermal insulating member 60. Each leg 41 may be entirely covered with the thermal insulating member 60 as shown in FIGS. 2 and 3. The thermal insulating member 60 may be present not only at the legs 41 but also between the body 42 and the electrically conductive layer 20.

The legs 41 are bonded to the electrically conductive layer 20 by the lead-free solder 50. The lead-free solder 50 has a high Young's modulus and a high rigidity. Glass has a coefficient of thermal expansion of 8.5×10⁻⁶ to 9×10⁻⁶/° C. while the copper and the brass (tombac) applicable to the legs 41 have a coefficient of thermal expansion of 16.5×10⁻⁶ to 17×10⁻⁶/° C. and a coefficient of thermal expansion of 18×10⁻⁶ to 20×10⁻⁶/° C., respectively. In other words, since there is a significant difference in coefficient of thermal expansion between the vehicle window glass 10 and the legs 41, when the legs 41 are bonded to the electrically conductive layer 20 by the lead-free solder 50, a crack or the like could be formed on the glass plate or a terminal 40 could be peeled, by difference in expansion or shrinkage caused by heating or cooling. Nevertheless, in accordance with the first embodiment of the present invention, at least a portion of each leg 41 is covered with the thermal insulating member 60. Thus, even when the vehicle window glass 10 is heated or cooled in the hot and cold test performed prior to the use of the vehicle window glass 10 as a product, each leg 41 is difficult to be affected by a temperature change caused by the hot and cold test. For this reason, there is no likelihood that a crack or the like is formed on the glass plate or the terminal 40 is peeled, by the hot and cold test. It should be noted that the hot and cold cycle test is a test wherein operation as one cycle includes heating at 80° C. for 30 minutes, followed by cooling at −30° C. for 30 minutes, and this operation is repeated in 100 cycles.

The thermal insulating member 60 is preferred to be formed of at least one resin selected from the group consisting of a silicone-based resin, an epoxy-based resin and a urethane-based resin. When the thermal insulating member is at least one resin selected from the group consisting of a silicone-based resin, an epoxy-based resin and a urethane-based resin, the legs 41 are difficult to be affected by a temperature change caused by heating and cooling in the hot and cold cycle test, and the thermal insulating member 60 prevents moisture from entering the legs 41 from outside to improve the moisture-resistance performance of the terminal 40, which are preferred.

The legs 41 are at least partly surrounded by a barrier 70 in planar view. The thermal insulating member 60 is present between the legs 41 and the barrier 70. Although the barrier 70 may be disposed so as to surround the terminal 40 as shown in FIG. 3, the barrier 70 may be disposed so as to surround only the legs 41. In a case where the legs 41 are at least partly surrounded by the barrier 70, even when the thermal insulating member 60 has a low viscosity, the thermal insulating member 60 can be prevented from flowing out, and the thermal insulating member 60 is allowed to be disposed up to the height of the barrier 70. The barrier 70 is preferred to be at least one material selected from the group consisting of a synthetic resin, metal, glass and rubber. When the thermal insulating member 60 is formed of a material that has such a high viscosity enough to maintain its original shape, the barrier 70 may be omitted.

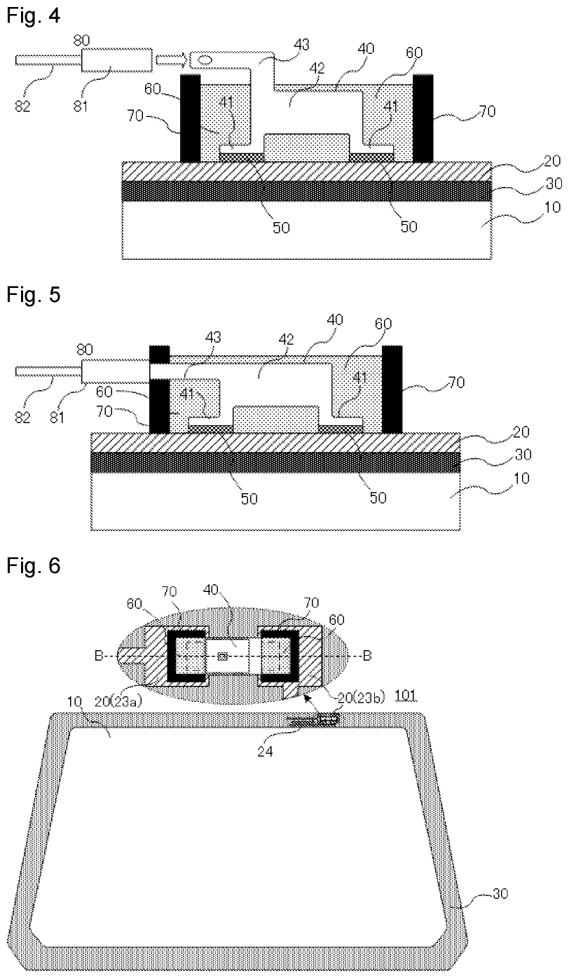

As shown in FIG. 4, the terminal 40 may be configured such that the legs 41, the body 42 and the coupling portion 43 are partly covered with the thermal insulating member 60. As shown in Fi. 5, the terminal 40 may be configured such that the legs 41, the body 42 and a part of the coupling portion 43 other than a part with the connector 81 of the external circuit coupler 80 to be inserted thereinto are covered by the thermal insulating member 60. In a case where the terminal 40 is configured such that the legs 41, the body 42 and the coupling portion 43 are at least partly covered with the thermal insulating member 60, even when the vehicle window glass 10 is heated and cooled in the hot and cold cycle test of the vehicle window glass 10 for use as a product, the hot and cold temperatures are difficult to be transmitted to the legs 41 through the body 42 and the coupling portion 43 of the terminal 40, making it difficult to cause a temperature change in the legs 41. Thus, there is no likelihood that a crack could be formed in the glass plate or the terminal 40 is peeled in the hot and cold cycle test. It should be noted, when the terminal 40 is configured such that the legs 41, the body 42 and the coupling portion 43 are at least partly covered with the thermal insulating member 60 as shown in FIGS. 4 and 5, the barrier 70 is preferred to have a larger height than the body 42 in cross-sectional view.

### Second Embodiment

As shown in FIG. 6, the vehicle window glass with a terminal 101 according to a second embodiment of the present invention includes an electrode 23 formed of an electrically conductive layer 20 disposed on at least one of principle surfaces of a vehicle window glass 10, and an antenna conductor 24 extending from the electrode 23, and further includes a terminal 40 connected to the electrode 23. Elements common to those of the vehicle window glass with a terminal 10 according to the first embodiment are denoted by like reference numerals, and explanation of the common elements will be omitted.

In the vehicle window glass with a terminal 101 according to the second embodiment, the electrode 23 includes a positive electrode 23a, and a negative electrode 23b disposed at a position apart from the positive electrode by a certain distance. It should be noted that the positions of the positive electrode 23a and the negative electrode 23b shown in this figure may be reversed. The antenna conductor 24 may be, for example, an antenna applied to the windshield of a vehicle or an antenna applied to the backlite or a side glass of a vehicle. The antenna conductor 24 is an antenna for an AM radio receiver, an FM radio receiver, a TV receiver, radio communication or the like. Radio wave signals for radio broadcasting, TV broadcasting or another communication are transmitted, through a coaxial cable 85 of an external circuit connector 80 described later, to a receiver (not shown), such as a radio receiver, or a TV receiver, mounted on the vehicle. The antenna conductor 24 extending from the positive electrode 23a and the negative electrode 23b may be a single antenna conductor or plural antenna conductors. The positive and negative electrodes may be configured in such a pattern that one of them is equipped with a single or plural antenna conductors 24 while the other is not equipped with any antenna conductor 24.

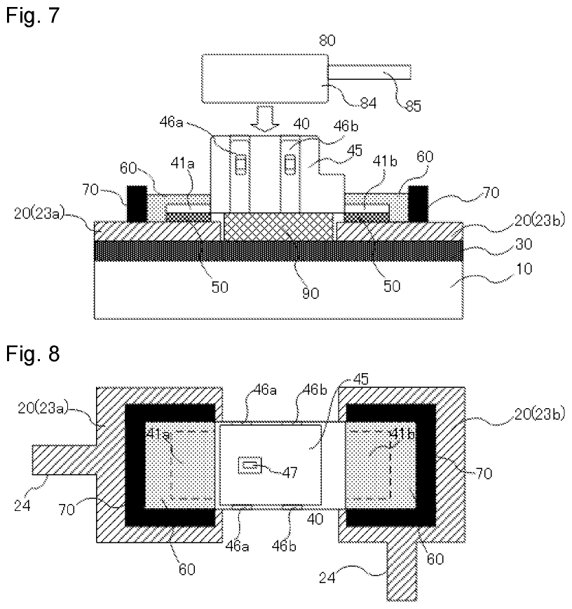

As shown in FIGS. 7 and 8, the terminal 40 includes legs 41, respectively, connected to the electrodes 23a and 23b, a holder 45, fixing members 46 and a coupler pin 47.

The holder 45 is formed of an insulating member made of a resin or the like and is configured to be erected on the primary surface of the vehicle window glass 10. The holder 45 has legs 41 (41a, 41b) disposed, on both end portions in a longitudinal direction, at positions to be connectable with the electrodes 23 (positive electrode 23a and negative electrode 23b) by lead-free solder 50, respectively. The fixing members 46 (46a, 46b) are disposed in a raised fashion so as to clamp both sides of the holder 45 and are electrically connected to the legs 41 (41a, 41b), respectively. The legs 41 and the fixing members 46 may be formed of the same material or may be formed of different materials so long as the legs are electrically connected to the fixing members 46. It should be noted that the legs 41 are preferred to be formed of a material having an electrical resistivity of 1×10⁻⁸ to 10×10⁻⁸ Ω·m, such as copper or brass (tombac) as in the first embodiment. The electrical resistivity is more preferred to be 1×10⁻⁸ to 10×10⁻⁸ Ω·m. The holder 45, except for the legs 41, may be fixed to the vehicle window glass 10 by an adhesive member 90 or the like. The adhesive member 90 may be a double sided tape or an adhesive. There is no particular limitation to the adhesive. For example, an acrylic resin-based adhesive, a urethane resin-based adhesive or an epoxy resin-based adhesive is applicable. The fixing members 46 are electrically coupled to conductors built in a pickup portion 84 described later. The coupler pin 47 extends vertically upward from an inner bottom of the holder 45 so as to be configured to be electrically coupled to the positive electrode 23a.

The external circuit connector 80 includes the pickup portion 84 and the coaxial cable 85 and is configured to be electrically connected to a receiver, such as a radio receiver or a TV receiver, when the pickup portion 84 is engaged with the holder 45. The pickup portion 84 is a hollow casing formed in a substantially rectangular parallelepiped shape and formed of an electrically insulating material, such as a resin. The pickup portion 84 has a hollow portion, which includes conductors such that the conductors are connected to the fixing members 46a, the coupler pin 47 and the fixing members 46b, respectively, when the pickup portion is engaged with the holder. The fixing members 46a and the coupler pin 47, which are electrically connected to the positive electrode 23a via the lead-free solder 50 and the leg 41a, are to be connected to a signal conductor (core conductor) of the coaxial cable. The fixing members 46b, which are electrically connected to the negative electrode 23b via the lead-free solder 50 and the leg 41b, are to be connected to a ground conductor (outer conductor) of the coaxial cable.

In the vehicle window glass with a terminal 101 shown in FIG. 7, only the legs 41a and 41b are covered with thermal insulating members 60. In other words, although only the legs 41 are covered with the thermal insulating members 60 in the second embodiment, the holder 45 is formed of the thermal insulating member. Even when the vehicle window glass 10 is heated and cooled in the hot and cold cycle test of the vehicle window glass 10 for use as a product, not only the legs 41 but also the holder 45 are difficult to be affected by a temperature change caused by the hot and cold cycle test. Thus, there is no likelihood that a crack or the like is formed in the glass plate or the terminal 40 is peeled in the hot and cold cycle test. Since the thermal insulating member 60 prevents moisture from entering the legs 41a and 41b from outside, the moisture resistance of the terminal 40 is advantageously improved. It should be noted that in the second embodiment, the terminal may be configured such that not only the legs 41 but also the remaining parts of the terminal are covered with the thermal insulating members 60 to such an extent not to impair the engagement of the pickup 84 with the holder 45.

### INDUSTRIAL APPLICABILITY

The vehicle window glass with a terminal according to the present invention is appropriately applicable to a windshield, a sliding window, a fixed window, a backlite or another window glass.

### REFERENCE SYMBOLS

100, 101: vehicle window glass with a terminal
10: vehicle window glass
20: electrically conductive layer
21: bus bar
22: heating member
23: electrode, 23a: positive electrode, 23b: negative electrode
24: antenna conductor
30: light-shielding layer
40: terminal
41, 41a, 41b: leg
42: body
43: coupling portion
45: holder
46, 46a, 46b: fixing members
47: coupler pin
50: lead-free solder
60: thermal insulating member
70: barrier
80: external circuit coupler
81: connector
82: cable
84: pickup portion
85: coaxial cable
90: adhesive member

What is claimed is:

1. A vehicle window glass with a terminal comprising:
a glass plate;
an electrically conductive layer disposed on a surface of the glass plate; and
a terminal connected, by lead-free solder, to the electrically conductive layer,
wherein the terminal includes at least one leg connected to the electrically conductive layer by the lead-free solder, and
wherein at least one portion of the leg is covered with a thermal insulating member.

2. The vehicle window glass according to claim 1, wherein the leg has an electrical resistivity of 1×10⁻⁸ to 10×10⁻⁸ Ω·m.

3. The vehicle window glass according to claim 1, wherein the thermal insulating member is formed of at least one resin selected from the group consisting of a silicone-based resin, an epoxy-based resin and a urethane-based resin.

4. The vehicle window glass according to claim 1, wherein the leg is at least partly surrounded by a barrier in planar view, and the thermal insulating member is present between the leg and the barrier.

5. The vehicle window glass according to claim 4, wherein the barrier is formed of at least one material selected from the group consisting of a synthetic resin, metal, glass and rubber.

6. The vehicle window glass according to claim 1, wherein the terminal is disposed in the vicinity of an end portion of an upper side or a lateral side of the vehicle window glass.

7. The vehicle window glass according to claim 1, wherein the terminal further comprises:
a body electrically connected to the leg and being erected from the leg; and
a connection portion extending from the body and electrically connected to the body;
wherein the leg, the body and the connection portion are formed of the same material; and
the leg, the body and the connection portion are partly covered with the thermal insulating member.

8. The vehicle window glass according to claim 7, wherein the barrier has a larger height than the body in cross-sectional view.

9. The vehicle window glass according to claim 1, wherein the terminal further comprises a holder formed of an electrically insulating material;
the leg comprises legs disposed on both end portions of the holder in a longitudinal direction; and
the holder has fixing members disposed so as to sandwich both lateral sides thereof, the fixing members being electrically connected to the legs.

10. The vehicle window glass according to claim 9, wherein the thermal insulating member covers only the legs.
